(19) United States
(12) Patent Application Publication
(10) Pub. No.: US 2009/0014497 A1
(43) Pub. Date: Jan. 15, 2009

(54) APPARATUS FOR WELDING UPPER AND LOWER PLATES OF METAL SEPARATING PLATE OF FUEL CELL

(76) Inventor: Sung Phil Ryu, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/970,256

(22) Filed: Jan. 7, 2008

(30) Foreign Application Priority Data
Jul. 13, 2007 (KR) 10-2007-0070744

(51) Int. Cl. B23K 20/12

(52) U.S. Cl. 228/2.3

(57) ABSTRACT

Provided is an apparatus for welding upper and lower plates of a metal separating plate of a fuel cell which can simplify the welding of a separating plate, improve welding and watertight performance, and prevent the thermal deformation of a separating plate. The apparatus includes a supporting unit which is disposed below a main body and on which the metal separating plate is safely seated; a friction stir unit which faces the supporting unit, and welds the metal separating plate using a friction stir welding method; and a temperature control unit which is disposed either at the friction stir unit or at the supporting unit, measures a temperature of at least a portion of the metal separating plate during the welding, and controls an operation of the friction stir unit so that the temperature of the metal separating plate can be maintained within a predetermined range.

This application claims priority from Korean Patent Application No. 10-2007-0070744 filed on Jul. 13, 2007 in the Korean Intellectual Property Office, the disclosure of which is incorporated herein by reference in its entirety.

### BACKGROUND OF THE INVENTION

1. Field of the Invention

The present invention relates to an apparatus for welding upper and lower plates of a metal separating plate of a fuel cell, and more particularly, to an apparatus for welding upper and lower plates of a metal separating plate of a fuel cell which can simplify the welding of an upper plate and a lower plate of a separating plate, can improve welding performance and watertight performance, and can prevent the thermal deformation of a separating plate of a fuel cell.

2. Description of the Related Art

In general, fuel cells are electrochemical devices which convert the chemical energy of hydrogen and oxygen into electrical energy. Fuel cells can continuously produce electricity by supplying hydrogen and oxygen to a cathode and an anode. Fuel cells are classified into an alkaline fuel cell (AFC), a phosphoric acid fuel cell (PAFC), a molten carbonate fuel cell (MCFC), a solid oxide fuel cell (SOFC), and a polymer electrolyte membrane fuel cell (PEMFC) according to the operating temperatures of fuel cells and the types of electrolytes used by fuel cells. PEMFCs which use a polymer electrolyte and a platinum catalyst are widely used in the manufacture of automobiles.

FIG. 1 illustrates the manufacturing process of a stack module of a typical fuel cell, FIG. 2 illustrates the structure of a stack module of the fuel cell illustrated in FIG. 1, and FIG. 3 illustrates various conventional methods of welding an upper plate and a lower plate of a separating plate.

The manufacture of a stack module of a typical fuel cell will hereinafter be described in detail with reference to FIG. 1. Referring to FIG. 1(a), a plurality of separating plates 2 and a plurality of membranes 4 are fabricated separately. The separating plates 2 may be formed of a metal or graphite. Since the manufacturing cost of metal separating plates is lower than the manufacturing cost of graphite separating plates, and metal separating plates can be fabricated by press molding, metal separating plates are being widely used. Referring to FIG. 1(b), the separating plates 2 are alternately stacked with the membranes 4, thereby completing the formation of a stack 6. Referring to FIGS. 1(c) and 1(d), a plurality of stacks 6 are combined, thereby completing the fabrication of a stack module 8.

Referring to FIG. 2, a stack 6 has a sandwich structure by including a membrane 4 which is interposed between each pair of adjacent metal separating plates 2. A plurality of metal separating plates 2 generate electric energy by reacting hydrogen (H) with oxygen (O), and adjust the temperature of the reaction using cold water (W). Each of the metal separating plates 2 includes an upper plate 2a and a lower plate 2b and a plurality of cold water containers 3 which are formed between the upper plate 2a and the lower plate 2b and contain cold water (W). The membrane 4 is a polymer electrolyte membrane. The membrane 4 is an insulator. However, the membrane 4 easily transmits hydrogen ions therethrough, and can thus serve as an excellent conductor for hydrogen ions. In short, the membrane 4 produces power by transmitting only hydrogen ions therethrough while blocking electrons obtained from hydrogen supplied thereto along with the hydrogen ions.

Referring to FIG. 3, the upper plate 2a and the lower plate 2b of the metal separating plate 2 may be bonded together in various manners. FIG. 3(a) illustrates a method of welding the upper plate 2a and the lower plate 2b together using a laser beam 10, FIG. 3(b) illustrates a method of bonding the upper plate 2a and the lower plate 2b using a glue 12, and FIG. 3(c) illustrates a method of coupling the upper plate 2a and the lower plate 2b using a gasket 14.

The method of FIG. 3(a), however, requires an apparatus for generating the laser beam 10 and thus results in an increase in facility investment. However, the method of FIG. 3(a) is highly likely to cause the metal separating plate 2 to be thermally deformed due to heat resulting from a welding operation. Moreover, the method of FIG. 3(a) is highly likely to cause welding defects in overheated portions of the metal separating plate 2.

The method of FIG. 3(b) comprises complicated processes such as applying, compressing and thermally plasticizing the glue 12. In addition, if too much glue is used, the glue 12 may leak out of the metal separating plate 2. On the other hand, if too little glue is used, the upper plate 2a and the lower plate 2b may not be able to be properly bonded together. Moreover, the method of FIG. 3(b) is difficult to automate. Furthermore, if the glue 12 is quickly plasticized at high temperature, the metal separating plate is highly likely to be thermally deformed. On the other hand, if the glue 12 is slowly plasticized at room temperature, the shape of the glue 12 may need to be maintained until the plasticization of the glue 12 is complete.

The method of FIG. 3(c) is a method of mechanically coupling the upper plate 2a and the lower plate 2b using a joint, i.e., using the gasket 14. Thus, the method of FIG. 3(c) requires manual labor due to the limitations of a mechanical coupling technique and may cause the deterioration of watertight performance.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention provides an apparatus for welding upper and lower plates of a metal separating plate of a fuel cell. The apparatus has a simple structure and can simplify the welding of an upper plate and a lower plate of a metal separating plate, improve welding performance and watertight performance and prevent the thermal deformation of a separating plate.

According to an aspect of the present invention, there is provided an apparatus for welding upper and lower plates of a metal separating plate of a fuel cell, the apparatus including a supporting unit which is disposed beside a main body of the apparatus and on which the metal separating plate is safely seated; a friction stir unit which is disposed above the metal separating plate, faces the supporting unit, and welds the upper plate and the lower plate using a friction stir welding method wherein a friction unit of the friction stir unit is rotated and pressed on the separating plate; and a temperature control unit which is disposed either at the friction stir unit or at the supporting unit, measures a temperature of the metal separating plate during the separating plate, and controls an operation of the friction stir unit so that the temperature of the metal separating plate during the welding process of the separating plate can be maintained within a predetermined range.

The metal separating plate comprising an upper plate and a lower plate may further include a recess portion which is formed at a welded portion of the metal separating plate where the upper plate and the lower plate are welded together. The recess portion includes a pair of lateral surfaces which are inclined so that a horizontal distance between the lateral surfaces may become greater as measuring from a bottom portion to a top portion of the recess portion. The friction stir unit may include a friction rod which stands upright, has a predetermined diameter and contacts the lateral surfaces of the recess portion, a rotator which is connected to an upper portion of the friction rod and rotates the friction rod, and a friction rod transporter which is disposed between the rotator and the main body and vertically reciprocates the friction rod and the rotator.

The friction rod may include a connection rod which is connected to the rotator and is rotated by the rotator, and a friction unit which is connected at a lower portion of the connection rod and contacts the lateral surfaces of the recess portion.

A diameter of the friction unit may be less than a horizontal distance between top portions of both lateral surfaces of the recess portion and greater than a horizontal distance between both bottom portions of the lateral surfaces of the recess portion.

A material of the friction unit may be more rigid and heat-resistant than a material of the metal separating plate.

The supporting unit may include a supporter which conforms to a shape of the welded portion of the metal separating plate.

The supporter may include at least a roller which moves the metal separating plate and is rollably disposed on seating surfaces of the supporter on which the lateral surfaces of the metal separating plate is seated.

The supporting unit may further include a supporter transporter which is disposed between the supporter and the main body and vertically reciprocates the supporter.

The temperature control unit may include at least a first temperature sensor which senses a temperature of a first portion of the metal separating plate that is thermally deformed severely by the welding of the upper plate and the lower plate, at least a second temperature sensor which senses a temperature of a second portion of the metal separating plate that stably transmits heat resulting from the welding of the upper plate and the lower plate, and a controller which controls an operation of the rotator according to the results of the sensing performed by the first temperature sensor and/or the second temperature sensor.

The first and second temperature sensor may include contactless infrared heat detection sensors.

The first temperature sensor may sense a temperature of a first portion of the metal separating plate near to the upper portion of the recess portion.

The second temperature sensor may sense a temperature at a second portion disposed on a bottom portion of the recess portion.

If the result of the sensing performed by the first temperature sensor indicates that the temperature of the first portion of the metal separating plate is higher than a first reference temperature, the controller may control the operation of the rotator so that a rotation speed of the friction rod can decrease.

If the result of the sensing performed by the second temperature sensor indicates that the temperature of the second portion of the metal separating plate is lower than a second reference temperature, the controller may control the operation of the rotator so that the rotation speed of the friction rod can increase, the second reference temperature being lower than the first reference temperature.

The above summary of the invention is not intended to describe each disclosed embodiment of the present invention. This is the purpose of the figures and of the detailed description that follows.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates the manufacture of a stack module of a typical fuel cell;

FIG. 2 illustrates the structure of a stack of the fuel cell illustrated in FIG. 1;

FIG. 3 illustrates various conventional methods of welding an upper plate and a lower plate of a metal separating plate;

FIG. 4 explains a friction stir welding method which is applied to an apparatus for welding an upper plate and a lower plate of a metal separating plate of a fuel cell according to an embodiment of the present invention;

FIG. 5 illustrates a perspective view of an apparatus for welding an upper plate and a lower plate of a metal separating plate of a fuel cell according to an embodiment of the present invention;

FIG. 6 illustrates a front view of the apparatus illustrated in FIG. 5;

FIG. 7 illustrates a detailed perspective view of the apparatus illustrated in FIG. 5;

FIG. 8 illustrates a detailed front view of the apparatus illustrated in FIG. 5;

FIG. 9 illustrates a perspective view of a friction rod of the apparatus illustrated in FIG. 5;

FIG. 10 illustrates a block diagram of a system for controlling the apparatus illustrated in FIG. 5;

FIG. 11 illustrates a flowchart of a method of controlling the apparatus illustrated in FIG. 5; and

FIG. 12 illustrates a graph of welding temperature variations during an operation of the apparatus illustrated in FIG. 5.

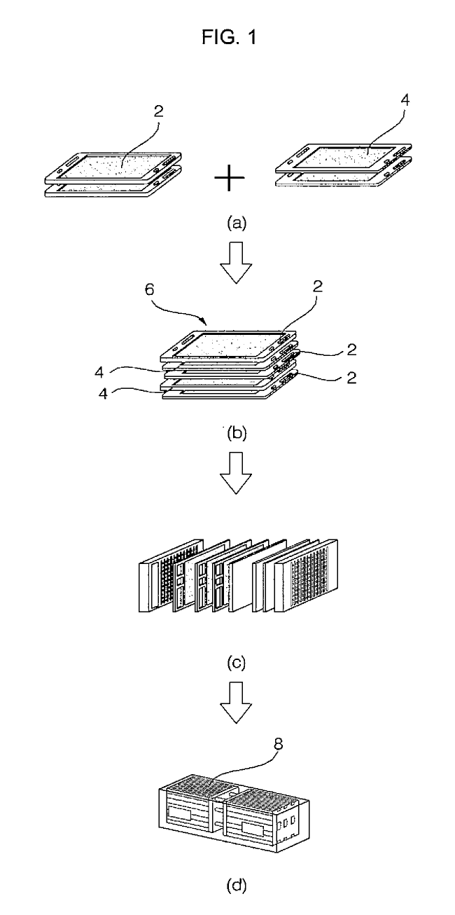

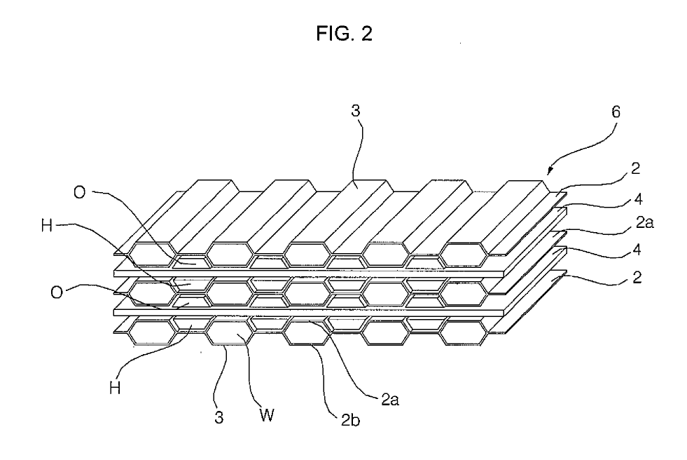

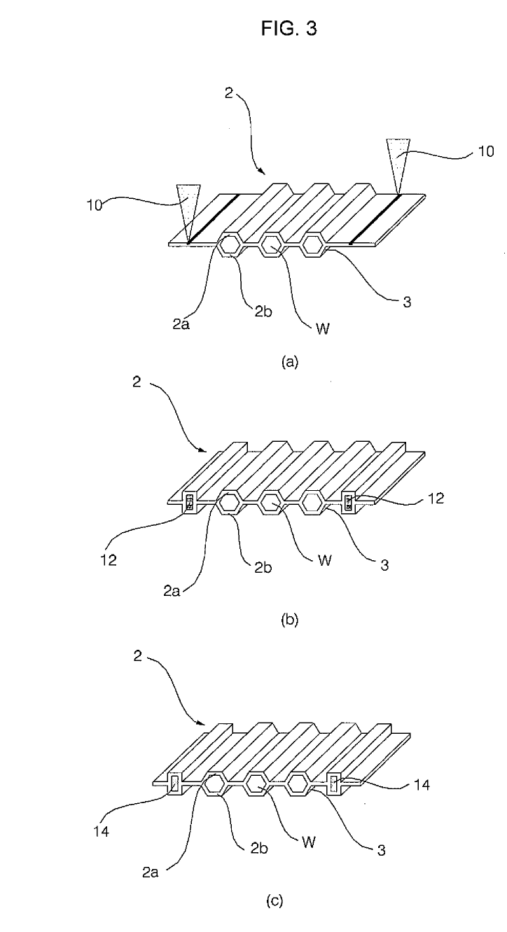

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

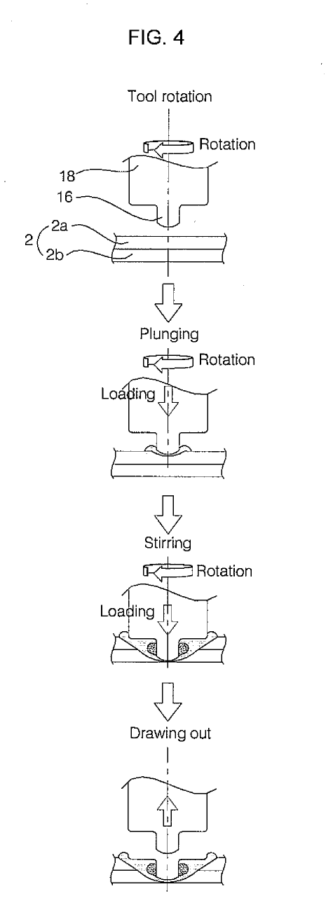

FIG. 4 explains a friction stir welding method which is applied to an apparatus for welding an upper plate and a lower plate of a metal separating plate of a fuel cell according to an embodiment of the present invention. Referring to FIG. 4, an upper plate 2a and a lower plate 2b of a metal separating plate 2 are welded using the friction stir welding method. In other words, the upper plate 2a is pressurized by rotating a tool 18 attached with a protrusion 16 positioned at the distal end of the tool 18. Then, heat is generated due to the friction and plastic flow between the tool 18 and the metal separating plate 2. As a result, the upper plate 2a and the lower plate 2b are softened and stirred so that they can be welded together in a solid state. In short, by applying local friction using the friction stir welding method, it is possible to considerably reduce the generation of heat and pollutants because the heat is focused on the local area where the friction is generated, simplify the structure of an apparatus for welding an upper plate and a lower plate of a metal separating plate of a fuel cell, and reduce the consumption of electricity.

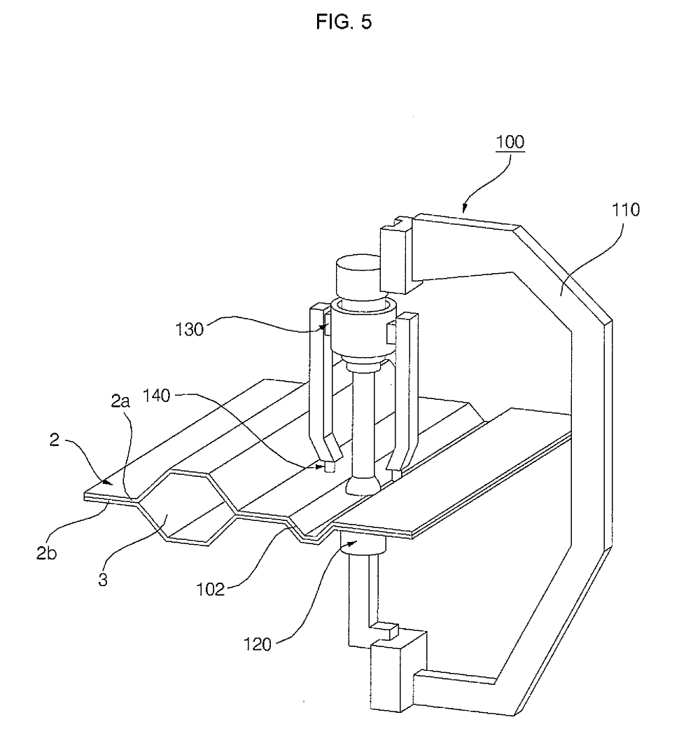

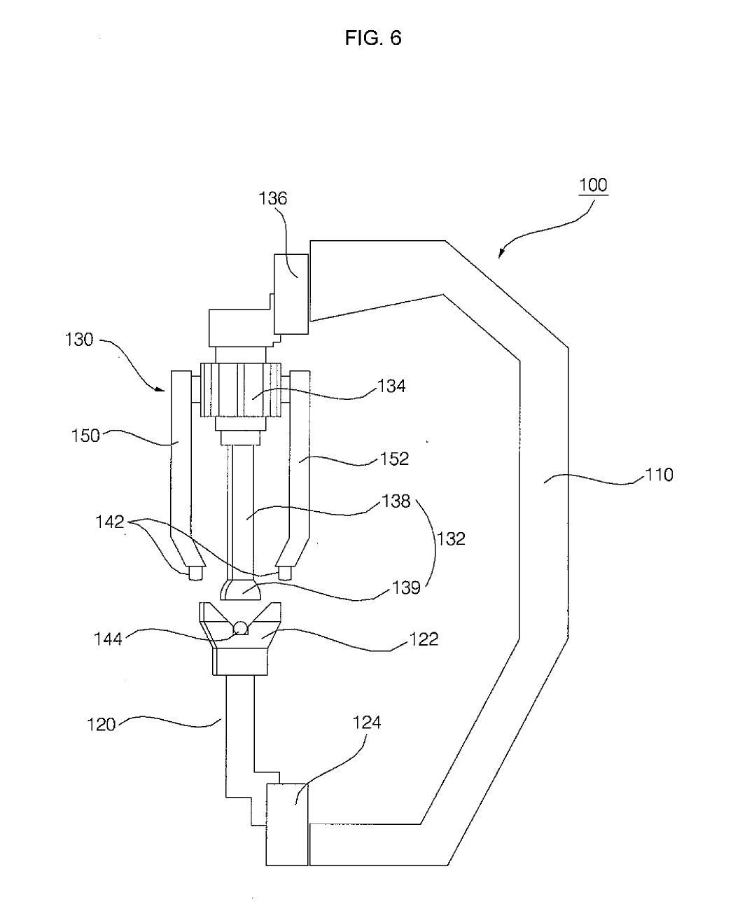

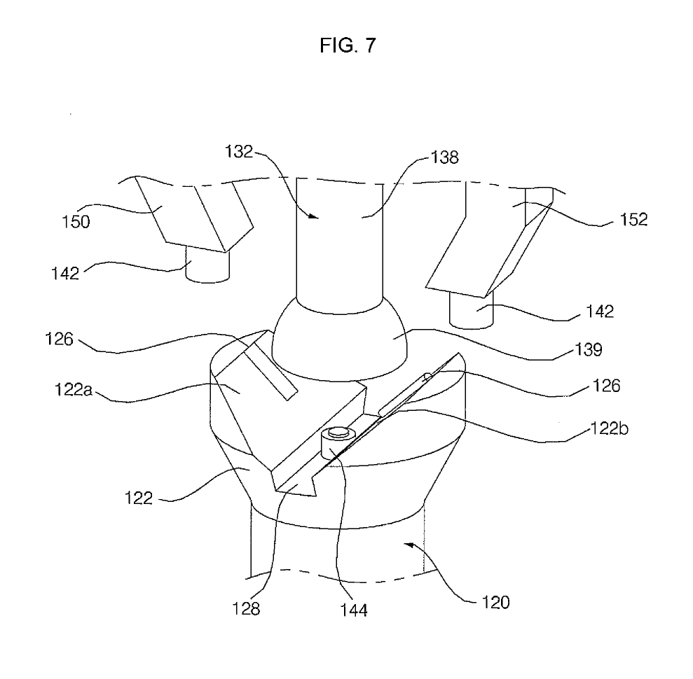

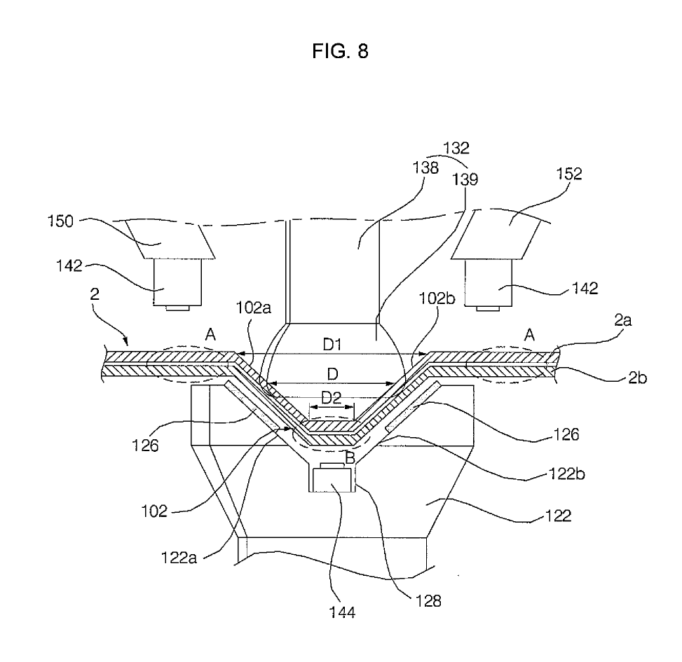

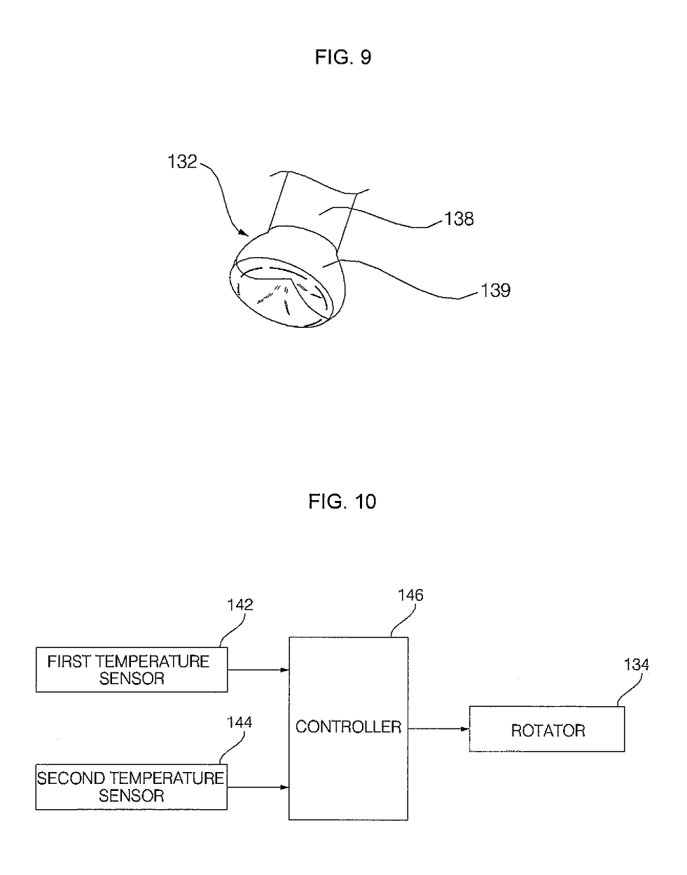

FIG. 5 illustrates a perspective view of an apparatus (hereinafter referred to as the metal separating plate welding apparatus) 100 for welding an upper plate and a lower plate of a metal separating plate of a fuel cell according to an embodiment of the present invention, FIG. 6 illustrates a front view of the metal separating plate welding apparatus 100, FIG. 7 and 8 illustrate a detailed perspective view and a detailed front view, respectively, of the metal separating plate welding apparatus 100, and FIG. 9 illustrates a perspective view of a friction rod 132 of the metal separating plate welding apparatus 100.

Referring to FIGS. 5 and 6, the metal separating plate welding apparatus 100 includes a main body 110; a supporting unit 120 which is disposed at a lower portion of the main body 110 and which can safely seat a metal separating plate 2 thereon; a friction stir unit 130 which welds an upper plate 2a and a lower plate 2b of the metal separating plate 2 using the friction stir welding method; and a temperature control unit 140 which is disposed in the friction stir unit 130 or in the supporting unit 120 and controls an operation of the friction stir unit 130 according to the temperature of the welding of the upper plate 2a and the lower plate 2b. The main body 110 defines a general framework of the metal separating plate welding apparatus 100, and accommodates the supporting unit 120, the friction stir unit 130, and the temperature control unit 140.

Referring to FIGS. 5 and 8, the metal separating plate 2 includes the upper plate 2a and the lower plate 2b which are welded together. A cold water container 3 is formed in a predetermined portion of the metal separating plate 2. More specifically, the cold water container 3 is an empty space formed between a convex portion of the upper plate 2a and a concaved portion of the lower plate 2b. The metal separating plate 2 also includes a recess portion 102 which is disposed at a portion of the metal separating plate at which the upper plate 2a and the lower plate 2b are welded together. The recess portion 102 has a pair of lateral surfaces 102a and 102b. A horizontal distance D disposed between both the lateral surfaces 102a and 102b becomes wider as measuring from the bottom portion to the top portion of the recess portion 102. In other words, the lateral surfaces 102a and 102b are slanted from bottom portion of the recess 102 so that the recess portion 102 may become V-shaped.

Referring to FIGS. 6, 7, and 8, the supporting unit 120 includes a supporter 122 which conforms to the shape of the recess portion 102 of the metal separating plate 2 and can thus safely seat the recess portion 102 thereon; and a supporter transporter 124 which is disposed between the supporter 122 and the main body 110 and vertically reciprocates the supporter 122. The supporter 122 has a plurality of seating surfaces, e.g., a left seating surface 122a and a right seating surface 122b which can safely seat the recess portion 102 of the metal separating plate 2 on the supporter 122. At least a roller 126 is rollably disposed on the left and right seating surfaces 122a and 122b. The left and right seating surfaces 122a and 122b, like the lateral surfaces 102a and 102b of the recess portion 102, are inclined so as to form a V shape together to accommodate the lateral surfaces 102a and 102b of the recess portion 102. In order to linearly reciprocate the supporter 122 in a vertical direction, the supporter transporter 124 may include a linear motor which is disposed between the supporter 122 and the main body 110.

Referring to FIGS. 5 and 6, the friction stir unit 130 includes the friction rod 132 which has a predetermined diameter, stands upright, and contacts the lateral surfaces 102a and 102b of the recess portion 102; a rotator 134 which is connected to an upper portion of the friction rod 132 and rotates the friction rod 132; and a friction rod transporter 136 which is disposed between the rotator 134 and the main body 110 and vertically reciprocates the rotator 134. In order to rotate the friction rod 132 at various rotation speeds, the rotator 134 may include a motor whose rotation axial member is connected to the upper portion of the friction rod 132. In order to linearly reciprocate the friction rod 132 in the vertical direction, the friction rod transporter 136 may include a linear motor which is disposed between the rotator 134 and the main body 110.

Referring to FIGS. 6, 8 and 9, the friction rod 132 includes a connection rod 138 which has an upper portion connected to the rotator 134 and is thus rotated by the rotator 134, and a friction unit 139 which is attached at a lower portion of the connection rod 138 and contacts both of the lateral surfaces 102a and 102b of the recess portion 102 in the welding process. The diameter D of the friction unit 139 is smaller than a maximum horizontal distance D1 measured between the upper portions of the lateral surfaces 102a and 102b of the recess portion 102 and is greater than a minimum horizontal distance D2 between the bottom portions of the lateral surfaces 102a and 102b of the recess portion 102. The friction unit 139 is formed of a material that is more durable and more heat-resistant than the material of the metal separating plate 2. Referring to FIG. 9, the friction unit 139 includes a cone-shaped dent portion which is formed at the bottom of the friction unit 139 and has a rounded bottom edge. The rounded bottom edge may increase the stress between the upper plate 2a and the lower plate 2b to generate heat while the upper plate 2a and the lower plate 2b is pressed in the welding process. The radius of the rounded bottom edge can be variously embodied by a person of ordinary skill in the art based on the teachings contained herein.

The friction unit 139 of the friction rod 132 may be pressed on the lateral surfaces 102a and 102b of the recess portion 102 by the friction rod transporter 136 and/or the supporter transporter 124 and the friction unit 139 of the friction rod 139 is rotated at high speed by the rotator 134 so that the upper plate 2a and the lower plate 2b can be friction-stir-welded.

Referring to FIGS. 6, 7 and 8, the temperature control unit 140 includes first temperature sensors 142 which sense the temperature of portions A of the metal separating plate 2 wherein the portions A are positioned near to the both distal sides of the recess portion 102; a second temperature sensor 144 which senses the temperature of a portion B, i.e., the bottom portion of the recess portion 102 of the metal separating plate 2, and a controller 146 which controls an operation of the rotator 134 according to the result of the sensing performed by the first temperature sensors 142 and the second temperature sensor 144.

The portions A are the local areas thermally deformed severely by a friction stir welding operation, and the portion B stably transmits heat resulting from the friction stir welding operation. The portions A are substantially near to the top portions of the lateral surfaces 102a and 102b of the recess portion 102, and the portion B is the bottom portion of the lateral surfaces 102a and 102b of the recess portion 102 comprising the upper plate 2a and lower plate 2b.

The first temperature sensors 142 are respectively disposed at the distal ends of a left bracket 150 and a right bracket 152 of the friction stir unit 130. The first temperature sensors 142 are contactless infrared heat detection sensors and sense the temperature of the portions A of the metal separating plate 2. The left bracket 150 and the right bracket 152 are coupled to the rotator 134, but are not rotated by the rotator 134. The left bracket 150 and the right bracket 152 are respectively disposed above the respective portions A disposed on the metal separating plate 2, and the first temperature sensors 142 are respectively attached to the respective distal ends of the left bracket 150 and the right bracket 152.

The second temperature sensor 144 is disposed on the supporter 122. The second temperature sensor 144 may also a contactless infrared heat detection sensor and senses the temperature of the portion B disposed on the bottom portion of the recess portion 102. The supporter 122 includes the left seating surface 122a, the right seating surface 122b and a sensor installation groove 128 which faces the portion B of the metal separating plate 2 and in which the second temperature sensor 144 is disposed. The second temperature sensor 144 is positioned under the portion B of the metal separating plate 2. The sensor installation groove 128 is offset downward to such a depth that the second temperature sensor 144 and the portion B of the metal separating plate 2 can be prevented from interfering with each other.

Referring to FIG. 10, if the result of sensing performed by the first temperature sensors 142 indicates that the temperature of the portions A of the metal separating plate 2 is higher than a first reference temperature, the controller 146 reduces the rotation speed of the friction rod 132 by controlling the operation of the rotator 134. If the result of sensing performed by the second temperature sensor 144 indicates that the temperature of the portion B of the metal separating plate 2 is lower than a second reference temperature that is lower than the first reference temperature, the control unit 146 increases the rotation speed of the friction rod 132 by controlling the operation of the rotator 134. The first reference temperature is the temperature at which the portions A of the metal separating plate 2 begin to be thermally deformed due to heat generating from a welding operation, and the second reference temperature is the temperature of the portion B of the metal separating plate 2 when a welding operation is performed at a minimum required temperature for friction stir welding.

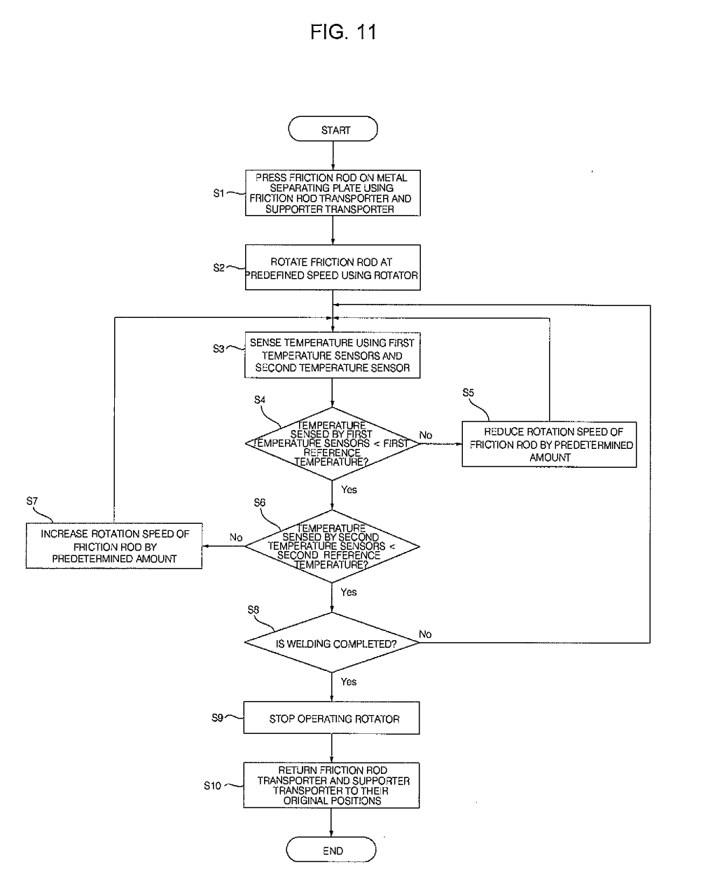

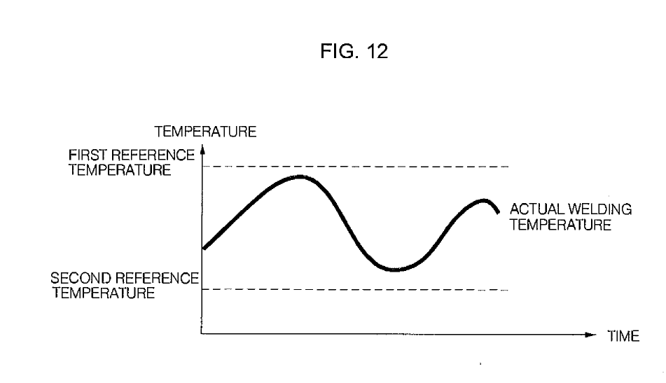

An operation and benefits of the apparatus illustrated in FIG. 5 will hereinafter be described in detail with reference to FIGS. 10 through 13. FIG. 10 illustrates a block diagram of a system for controlling the apparatus illustrated in FIG. 5, FIG. 11 illustrates a flowchart of a method of controlling the apparatus illustrated in FIG. 5, and FIG. 12 illustrates a graph of welding temperature variations during the operation of the apparatus illustrated in FIG. 5.

Referring to FIGS. 10 through 12, the recess portion 102 of the metal separating plate 2 is seated complimentarily on the supporter 122 of the supporting unit 120. Thereafter, the supporter transporter 124 is vertically lifted and/or the friction rod transporter 136 is vertically lowered. Due to the operation of the supporter transporter 124 and/or the friction rod transporter 136, the friction unit 139 of the friction rod 132 is pressed on the lateral surfaces 102a and 102b of the recess portion 102 (S1).

The rotator 134 rotates the friction rod 132 at a predefined speed. As a result, the contact areas between the friction unit 139 and the lateral surfaces 102a and 102b soften and melt due to friction heat or heat resulting from plastic flow. The softened and molten portions of the metal separating plate 2 are stirred due to the friction unit 139. Thereafter, the metal separating plate 2 is moved forward or backward so that welded lines are formed on the lateral surfaces 102a and 102b of the recess portion 102 in parallel along the longitudinal direction of the recess portion 102 (S2).

Thereafter, the first temperature sensors 142 sense the temperature of the portions A of the metal separating plate 2, and the second temperature sensor 144 senses the temperature of the portion B of the metal separating plate 2 (S3).

If the result of the sensing performed by the first temperature sensors 142 indicates that the temperature of the portions A of the metal separating plate 2 is higher than the first reference temperature (S4), the controller 146 reduces the rotation speed of the friction rod 132 by a predetermined amount by controlling the operation of the rotator 134 (S5). If the result of the sensing performed by the second temperature sensor 144 indicates that the temperature of the portion B of the metal separating plate 2 is lower than the second reference temperature (S6), the controller 146 increases the rotation speed of the friction rod 132 by a predetermined amount by controlling the operation of the rotator 134 (S7). The amount by which the rotation speed of the friction rod 132 is reduced or increased by the controller 146 may be determined in advance as a default or may be determined by a user. In this manner, it is possible to maintain an actual welding temperature during the welding of the upper plate 2a and the lower plate 2b of the metal separating plate 2 between the first reference temperature and the second reference temperature.

If the welding of the upper plate 2a and the lower plate 2b of the metal separating plate 2 is completed (S8), the friction rod transporter 136 and/or the supporter transporter 124 return to their original positions (S9 and S10).

According to the present invention, it is possible to simplify the welding of an upper plate and a lower plate of a metal separating plate during the manufacture of a fuel cell, improve welding performance and watertight performance through a single process, and prevent the thermal deformation of a separating plate.

In addition, according to the present invention, since an upper plate and a lower plate of a metal separating plate are friction-stir-welded together, it is possible to easily improve welding performance and watertight performance. Also, it is possible to automate a welding process and reduce the welding cost by simplifying a welding process and the structure of welding equipment.

Moreover, according to the present invention, it is possible to prevent the thermal deformation of a metal separating plate and optimize a friction stir welding operation by sensing the temperature of portions of a metal separating plate which are thermally deformed by a friction stir welding operation and the temperature of a portion of a metal separating plate which is actually welded and controlling an operation of a friction stir unit according to the results of the sensing.

Furthermore, according to the present invention, it is possible to form two welded lines through a single welding operation by performing a friction stir welding operation while pressing a friction rod of a friction stir unit on a pair of lateral surfaces of a recess portion of a metal separating plate.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the claims appended hereto and their equivalents

What is claimed is:

1. An apparatus for welding upper and lower plates of a metal separating plate of a fuel cell, the apparatus comprising:
a main body;
a supporting unit which is disposed below the main body and on which the metal separating plate is safely seated;
a friction stir unit which is disposed above the supporting unit, faces the supporting unit, and welds the metal separating plate by pressing the metal separating plate with rotating a friction unit to stir friction between the upper plate and the lower plate of the metal separating plate; and
a temperature control unit which is disposed either at the friction stir unit or at the supporting unit, measures temperature of at least a portion of the metal separating plate during the welding of the metal separating plate, and controls operation of the friction stir unit so that the temperature of the metal separating plate during the welding of the metal separating plate can be maintained within a predetermined range.

2. The apparatus of claim 1, wherein:
the metal separating plate further comprises a recess portion which is formed at a welded portion of the metal separating plate where the upper plate and the lower plate are welded together, wherein the recess portion comprises a pair of lateral surfaces which are inclined so that a horizontal distance between the lateral surfaces can become greater as measuring from a bottom portion to a top portion of the recess portion; and
the friction stir unit further comprises a friction rod which stands upright, has a predetermined diameter and contacts the lateral surfaces of the recess portion, a rotator which is connected to an upper portion of the friction rod and rotates the friction rod, and a friction rod transporter which is disposed between the rotator and the main body and vertically reciprocates the friction rod and the rotator.

3. The apparatus of claim 2, wherein the friction rod comprises a connection rod which is connected to the rotator and the friction unit wherein the connection rod and the friction unit are rotatably connected by the rotator, and the friction unit is disposed at a lower portion of the connection rod and contacts the lateral surfaces of the recess portion.

4. The apparatus of claim 3, wherein a diameter of the friction unit is less than a first horizontal distance between top portions of the lateral surfaces of the recess portion and greater than a second horizontal distance between bottom portions of the lateral surfaces of the recess portion.

5. The apparatus of claim 3, wherein a material of the friction unit is more rigid and more heat-resistant than a material of the metal separating plate.

6. The apparatus of claim 2, wherein the supporting unit comprises a supporter which conforms to a shape of the welded portion of the metal separating plate.

7. The apparatus of claim 6, wherein the supporter comprises at least a roller which moves the metal separating plate and is disposed on at least a seating surface of the supporter on which the metal separating plate is seated, the roller enabling the metal separating plate.

8. The apparatus of claim 6, wherein the supporting unit further comprises a supporter transporter which is disposed between the supporter and the main body and vertically reciprocates the supporter.

9. The apparatus of any one of claims 2 through 8, wherein the temperature control unit comprises:
a first temperature sensor which senses a temperature of a first portion of the metal separating plate that is thermally deformed severely by the welding of the upper plate and the lower plate;
a second temperature sensor which senses a temperature of a second portion of the metal separating plate that stably transmits heat resulting from the welding of the upper plate and the lower plate; and
a controller which controls an operation of the rotator according to the results of the sensing performed by the first temperature sensor and the second temperature sensor.

10. The apparatus of claim 9, wherein the first and second temperature sensor comprise contactless infrared heat detection sensors.

11. The apparatus of claim 9, wherein the first temperature sensor senses a temperature of a portion of the metal separating plate disposed near to at least a upper portion of the recess portion.

12. The apparatus of claim 9, wherein the second temperature sensor senses a temperature at a bottom portion of the recess portion.

13. The apparatus of claim 9, wherein, if the result of the sensing performed by the first temperature sensor indicates that the temperature of the first portion of the metal separating plate is higher than a first reference temperature, the controller controls the operation of the rotator so that a rotation speed of the friction rod can decrease.

14. The apparatus of claim 13, wherein, if the result of the sensing performed by the second temperature sensor indicates that the temperature of the second portion of the metal separating plate is lower than a second reference temperature, the controller controls the operation of the rotator so that the rotation speed of the friction rod can increase, in the predetermined range between the first reference temperature and the second reference temperature wherein the second reference temperature is lower than the first reference temperature.
